(19) United States
(12) Patent Application Publication
(10) Pub. No.: US 2002/0069937 A1
(43) Pub. Date: Jun. 13, 2002

(54) Method and apparatus for bucksawing logs

(76) Inventor: Robert James Murray, Richmond (CA)

Correspondence Address: Bruce M. Green, c/o Oyen Wiggs Green & Mutala, 480 - 601 West Cordova Street, Vancouver, BC, V6B 1G1, CA

(21) Appl. No.: 09/915,481

(22) Filed: Jul. 27, 2001

Related U.S. Application Data
(63) Continuation-in-part of application No. 09/302,180, filed on Apr. 30, 1999, now abandoned.

(30) Foreign Application Priority Data
Jul. 31, 2000 (CA) 2,314,778

(51) Int. Cl. B27B 1/00

(52) U.S. Cl. 144/379; 83/369; 83/732

(57) ABSTRACT

Previous methods of bucksawing logs slow the throughput of a sawmill in that the conveyor line is stopped while a given log is bucksawed to length. The present invention provides a method for bucksawing a log which improves the throughput speed. The present invention provides a method and apparatus for bucksawing a log comprising the steps of a) advancing the log endwise along a tilted infeed conveyor; b) positioning the log on a tilted feed roll above the level of an outfeed conveyor while advancing the log; c) measuring the advance of the log while on the tilted feed roll; d) stopping the log at the desired length; e) sawing the log to produce a forward log segment; f) moving the forward log segment onto a tilted outfeed conveyor while advancing the remaining log segments. The present invention further provides a method and apparatus for bucksawing a log comprising utilizing a second multi-positional cut-off saw in the bucksawing station. The present invention further provides a method for bucksawing a log comprising utilizing a shifting gap in the conveyor system associated with the second multi-positional cut-off saw in the bucksawing station. The present invention further provides a method and apparatus for bucksawing a log comprising utilizing two multi-positional cut-off saws in the bucksawing station for indefinite length cuts.

### CROSS REFERENCE TO RELATED APPLICATIONS

This application is a continuation-in-part of United States patent application Ser. No. 09/302,180 filed Apr. 30, 1999 which is pending.

### TECHNICAL FIELD

The invention relates to apparatus for cross-cutting or “bucksawing” long logs to produce logs of shorter length. More particularly the invention relates to a method and apparatus for feeding, positioning and holding a log for bucksawing to the desired length.

### BACKGROUND ART

It is important in the sawing of logs into lumber that the selection of saw cuts be made to maximize the quantity and quality of lumber which is yielded by the log, depending on the length, thickness and quality of the log, such as the presence of knots, defects and the like. As the first step in this process, the tree-length log is cut into shorter lengths, or “bucked”, prior to further processing. There are 'two commonly used methods of carrying this out in a sawmill. A first method is a transverse system whereby the tree-length log is moved sideways through a battery of buck saws where it is segmented simultaneously into shorter logs. This method is not particularly well suited to modifying the position of the cross cut to maximize the value and recovery from the log. A second method is the lineal bucking system whereby the tree-length log is moved endwise down the conveyor to a saw which bucks the log into shorter lengths one cut at a time. This method is better at maximizing the value and recovery from the log, but in both this method and the transverse method the speed of the transport conveyor is necessarily fixed at the speed the log moves through the sawing station, resulting in low throughput. For example, since the feed conveyor in the lineal bucking system must be stopped while the log is being bucked, there is no opportunity for closing the gaps between the logs on the feed conveyor.

The present inventor, as disclosed in his U.S. Pat. No. 5,680,802 issued on Oct. 28, 1997, provided a log bucksawing system in which the speed of the infeed or outfeed conveyors can be operated independently of the progress of the log at the sawing station to improve the throughput speed. The inventor has now discovered that the efficiency of the system can be improved by providing a second cut-off saw which is movable, and by making both dual cut-off saws movable.

### DISCLOSURE OF INVENTION

The present invention provides a method for bucksawing a log comprising the steps of a) advancing the log endwise along a tilted infeed conveyor; b) raising the log above the level of said infeed conveyor on a tilted feed roll while advancing the log; c) measuring the advance of the log while raised; d) stopping the log at the desired length; e) sawing the log to produce a forward log segment; and f) moving the forward log segment onto an outfeed conveyor while advancing the remaining log segments.

The present invention further provides a method for bucksawing a log comprising utilizing a second multi-positional cut-off saw in the bucksawing station. The present invention further provides a method for bucksawing a log comprising utilizing a shifting gap in the conveyor system associated with the second multi-positional cut-off saw in the bucksawing station.

The present invention further provides a method for bucksawing a log comprising utilizing dual multi-positional cut-off saws in the bucksawing station with one multi-positional cut-off saw being positioned on the infeed conveyor.

### BRIEF DESCRIPTION OF DRAWINGS

In drawings which disclose a preferred embodiment of the invention:

FIG. 1 is a schematic diagram showing a tilted feed apparatus in top view with the log on the infeed conveyor;

FIG. 2 is a schematic diagram showing the apparatus of FIG. 1 in top view with the log being positioned in the sawing station;

FIG. 3 is a schematic diagram showing the apparatus of FIG. 1 in top view with the log being sawn in the sawing station;

FIG. 4 is a schematic diagram showing the apparatus of FIG. 1 in top view with the sawn segment of the log on the outfeed conveyor;

FIG. 5 is a plan view of the feeding and bucking system according to FIG. 1;

FIG. 6 is an end view, partially cut-away and partially in section, of the cut-off saw and feed rolls of the apparatus in FIG. 1 with the rest position of the cut-off saw shown in phantom outline, and the saw blade removed for purposes of illustration;

FIG. 7 is an elevation of the cut-off saw and feed rolls of the apparatus in FIG. 1;

FIG. 8 is a plan view of the feed rolls of the apparatus in FIG. 1, showing a portion of the cut-off saw;

FIG. 9 is a plan view of the cut-off saw of the apparatus in FIG. 1, showing a portion of the feed rolls.

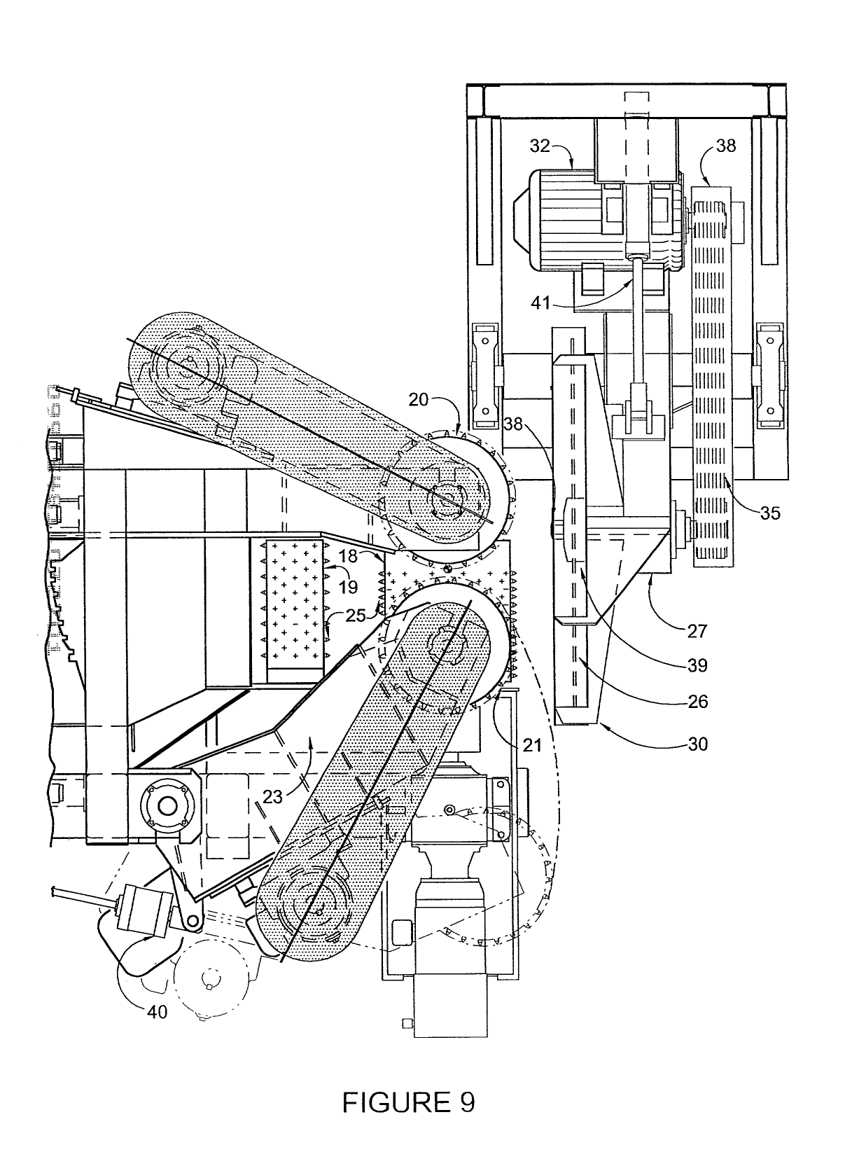

FIG. 10 is a partial end view showing the degree of tilt of the feed rolls of the apparatus in FIG. 1 with the multi-positional saw;

FIG. 11 is a plan view of an embodiment of the invention utilizing dual cut-off saws;

FIG. 12 is a detail plan view of the conveyor and feed roll associated with the second, multi-positional cut-off saw shown in FIG. 11;

FIG. 13 is a detail plan view of a the second, multi-positional cutoff saw shown in FIG. 11;

FIG. 14 is an elevation view of the second, multi-positional cut-off saw shown in FIG. 13;

FIG. 15 is an end view of the second, multi-positional cut-off saw shown in FIG. 13;

FIG. 16 is a plan view of a further embodiment of the multi-positional cut-off saw having a shifting conveyor;

FIG. 17 is a detail plan view of the embodiment of the invention shown in FIG. 16, with the conveyor portion in phantom outline for ease of illustration;

FIG. 18 is an end view of the multi-positional cut-off saw and belt shown in FIG. 16, with the conveyor portion in phantom outline for ease of illustration;

FIG. 19 is a plan view of the multi-positional cut-off saw and conveyor shown in FIG. 16, with the cut-off saw assembly in phantom outline for ease of illustration; and

FIG. 20 is a detail elevation view of the multi-positional cut-off saw and conveyor shown in FIG. 16, with the cut-off saw assembly not shown for ease of illustration;

FIG. 21 is an elevation view of the multi-positional cut-off saw and conveyor shown in FIG. 16, with the conveyor portion in phantom outline for ease of illustration;

FIGS. 22 and 23 are schematic elevation views of the shifting conveyor as shown in FIG. 19, in two extreme positions;

FIGS. 24 and 25 are end views of the tilted conveyor as shown in FIG. 19 as seen from the left and right ends respectively;

FIG. 26 is a detail elevation view of the multi-positional cut-off saw and conveyor shown in FIG. 20, with the cut-off saw assembly not shown for ease of illustration;

FIG. 27 is a plan view of a further embodiment of the invention utilizing dual cut-off saws, with the multi-positional cut-off saw being positioned on the infeed conveyor; and

FIG. 28 is a plan view of a fifth embodiment of the invention utilizing dual multi-positional cut-off saws.

### BEST MODE(S) FOR CARRYING OUT THE INVENTION

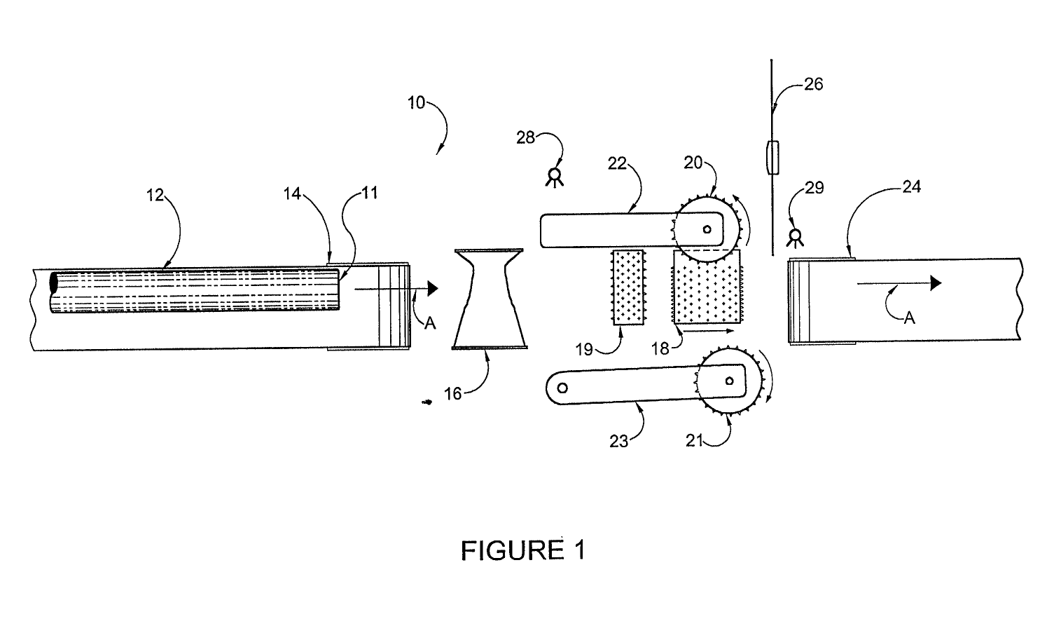

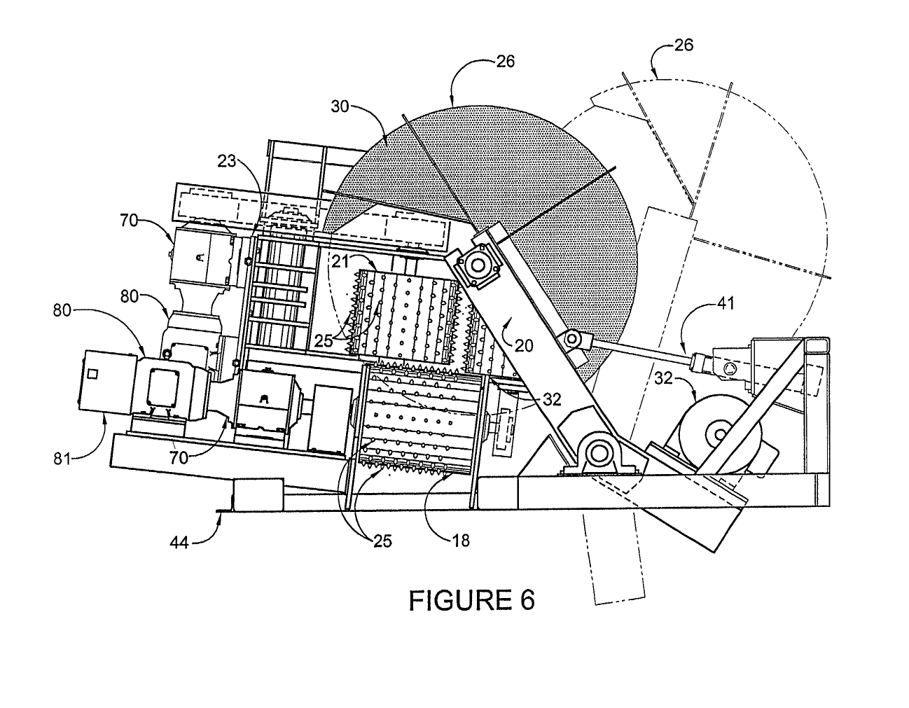

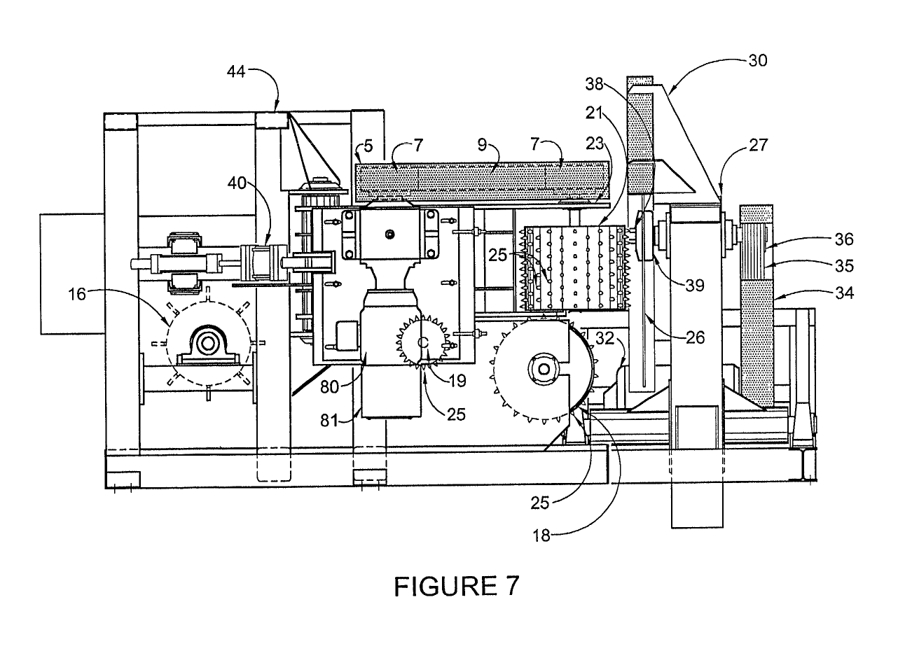

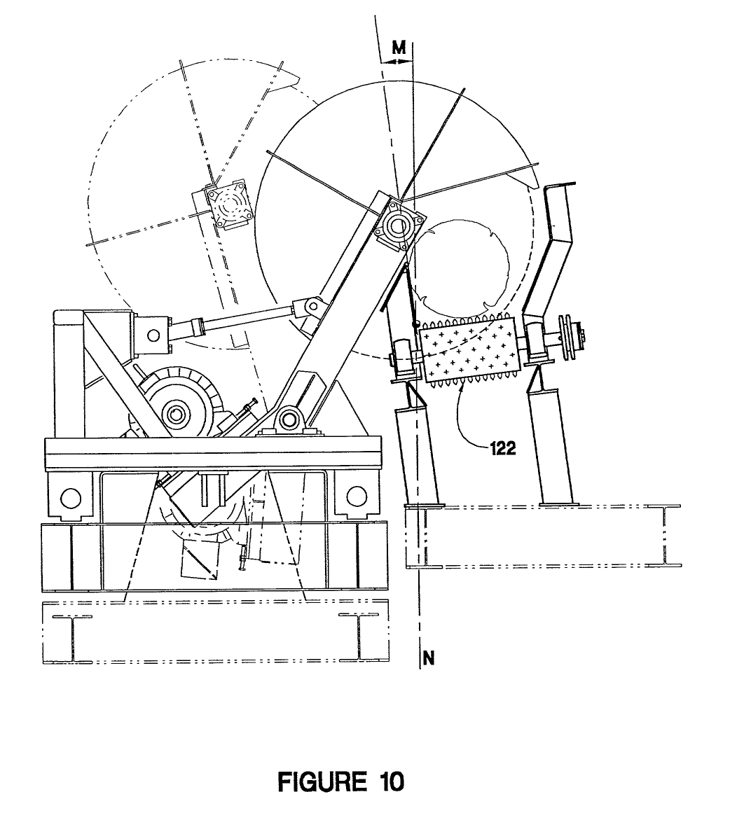

Looking at FIG. 1, the bucksawing apparatus, designated generally as 10, has a log 12 moving in the direction of arrow A on tilted infeed conveyor 14 towards a powered hourglass roll 16, tilted bottom feed rolls 18 and 19 and tilted side feed rolls 20 and 21. The degree of tilt of the conveyors and feed rolls is sufficient to cause the logs to roll to the proper feed line. As shown in FIG. 10, a degree of tilt M of 7 degrees from the vertical N has been found to be optimal. By uniformly tilting the infeed and outfeed conveyors and feed rolls by about 7 degrees, the log 12 is aligned against a barrier or guide to line up with feed roll 20 on fixed arm 22, so only one arm 23 need pivot. Feed rolls 18, 19, 20 and 21 are provided with spikes 25 (see FIG. 6 and 7) to grip the log 12 without slippage, and are rotatably driven by vector duty electric motors 80 with encoders 81 (see FIG. 6 and 7) through planetary gear reducers 70. The rotary motion of the output shaft of the planetary gear reducer 70 is transferred to the two spiked feed rolls 20 and 21 using timing sprockets 7, preferably Gates POLY CHAIN GT and timing belts 9, preferably Gates POLY CHAIN GT. the transmission system for rolls 20 and 21 are enclosed with a POLY CHAIN guard 5. This type of power transmission system is utilized to ensure that the transmission of power to the feed rolls 20, 21 is positive and eliminates the possibility of slippage in the drive system. The bottom feed roll 18 is direct coupled to the drive system planetary gear box 70 and vector drive electric motor 80 with encoder 81 so the drive system is positive and the possibility of slippage in the drive system is essentially eliminated. Preferably feed rolls 18, 19, 20 and 21 are all formed of extra strong steel pipe. Pointed spikes 25 are preferably ¾-inch in diameter by 1 and ¼ inches long and are welded on the pipe at 15 degree intervals.

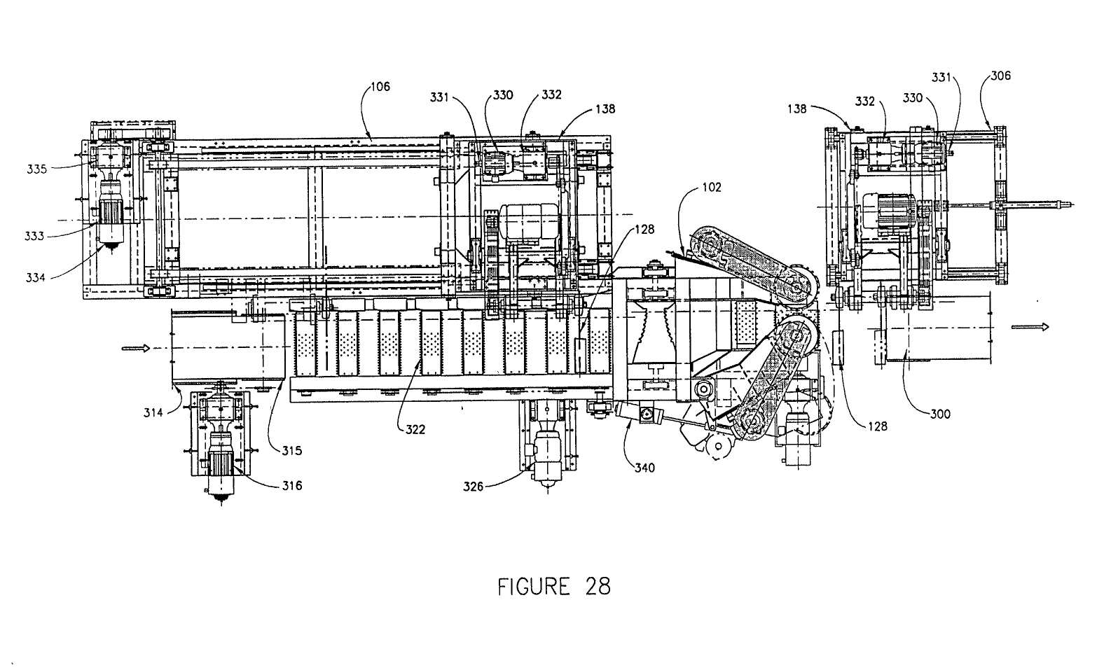

Tilted side feed roll 20 is mounted on a fixed arm 22 which is supported on frame 44. The other tilted side feed roll 21 is pivotally mounted on the end of arm 23 which is supported on frame 44 and pivoted by cylinder 40. The tilted outfeed conveyor is indicated at 24 and the cut-off saw is provided at 26 on a pivoting arm 27 (FIG. 7) or some other conventional means for swinging the cut-off saw 26 perpendicularly across the path of the log 12. Saw 26 has a saw guard 30, and is driven by electric motor 32 through drive belt 35 and sheave 36 on shaft 38. Saw 26 is held on shaft 38 by nut and collars 39. A belt guard 34 is provided. Arm 27 is pivoted by a position-sensing hydraulic cylinder 41 such as a REXROTH PRESSURE MASTER™ MT4-HH complete with TEMPOSONIC II™ probe TTS-RB-U-0240 or pivoted by vector duty electric motor 330 with encoder 331 as shown in FIG. 28. The tilted bottom feed rolls 18, 19 are mounted on frame 44.

Photocells 28, 29 detect the passage of the forward and trailing end of the log 12. Photocells 28, 29 provide a signal to a computer, central processing unit or programmable logic controller (not shown) which controls the operation of the tilted bottom rolls 18, 19, tilted fixed side roll 20, tilted side press roll 21 and cut-off saw pivot arm 27.

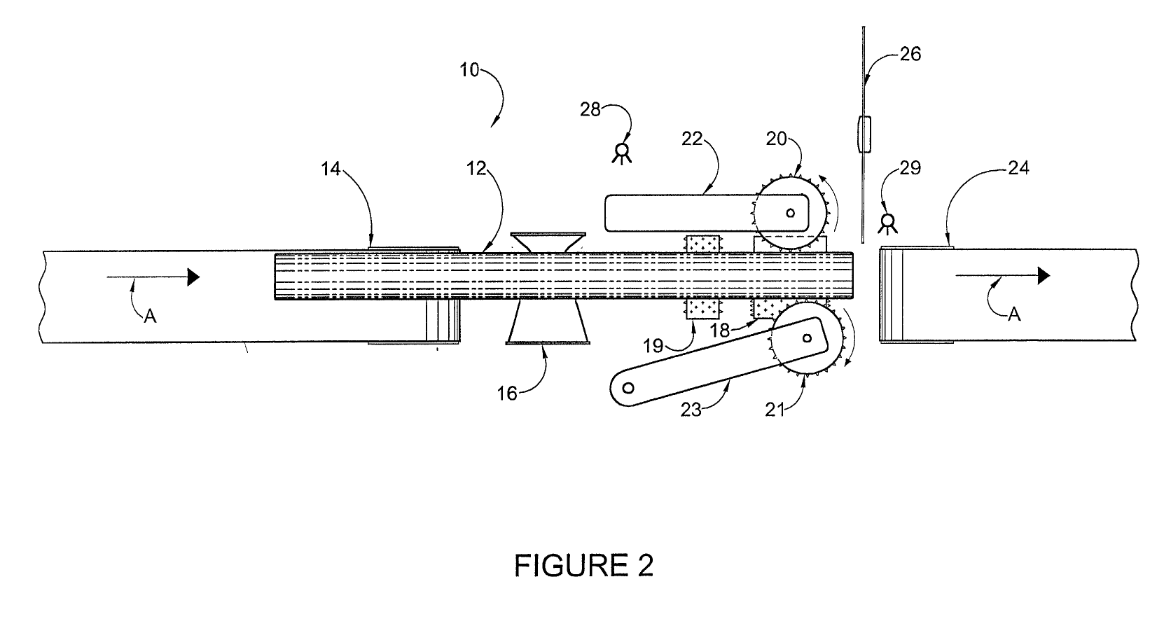

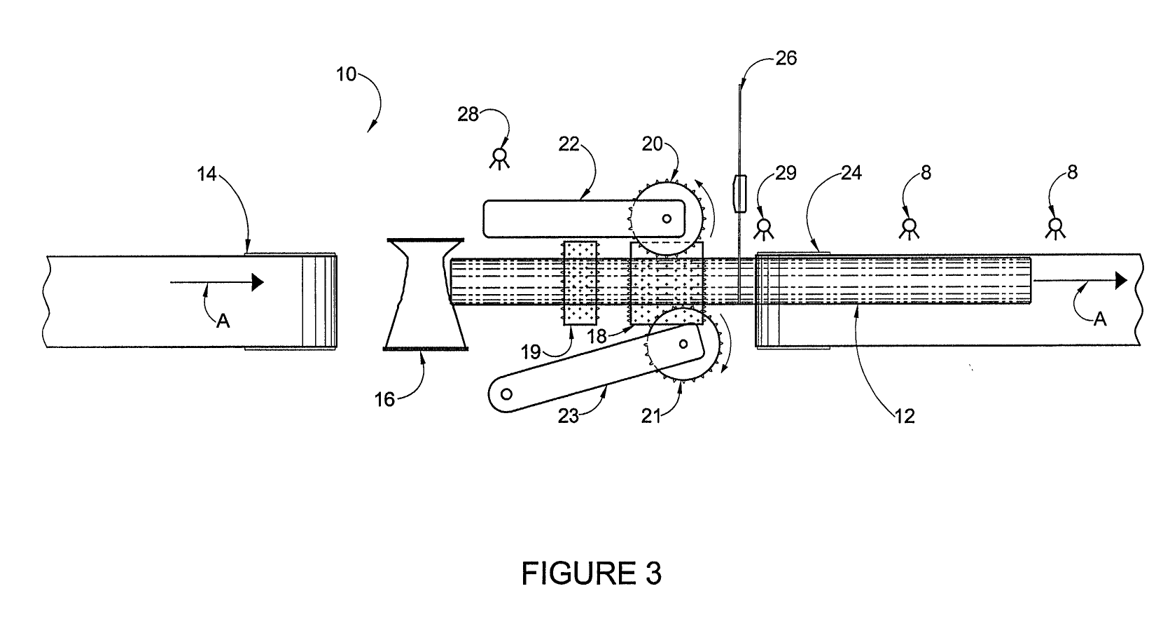

The tilted infeed and outfeed conveyors 14 and 24, which may be belts or chains, which can be run at a fixed, constant speed, although a variable speed is normally used with this system. When the tilted feed system is not feeding or bucking a log, the tilted side rolls 20, 21 and tilted bottom rolls 18, 19 can be run at the same speed as the tilted infeed or outfeed conveyors. The log 12 will have been scanned prior to arrival at the tilted infeed conveyor 14 and this scanning information is used to determine the location of the cuts made by cut-off saw 26. As the tilted infeed conveyor 14 conveys log 12 towards the cut-off saw 26, the tilted side feed roll 21 is in the open position shown in FIG. 1, swung away from the tilted bottom feed rolls 18, 19 and tilted fixed side feed roll 20. As shown in FIG. 2, as the log 12 is conveyed towards cut-off saw 26, it is aligned along the desired feed line whereby one edge will contact fixed feed roll 20, by hourglass roll 16, the surface of which is curved to direct log 12 to the fixed side of the tilted feed apparatus 10. The surface of hourglass roll 16 and the tilted bottom feed rolls 18, 19 are about 1 (one) inch higher than the surface of the tilted infeed conveyor 14, and as the forward end 11 of log 12 makes contact with hourglass roll 16 and the tilted bottom feed rolls 18, 19 it is lifted slightly above the level of infeed conveyor 14. When the forward end 11 of log 12 trips the photocells 28 located between hourglass roll 16 and the bottom feed roll 19, the tilted side feed roll 21 is pivoted inwardly and pre-positioned on arm 23 to the approximate diameter of the log 12. As the forward end 11 of log 12 progresses to a position between the tilted side feed rolls 20, 21, full hydraulic pressure is applied to the hydraulic cylinder 40 or the pneumatic linear positioning system (not shown) air is applied to the pneumatic cylinder 340 as shown in FIG. 28, so that the tilted side press roll 21 is pivoted inwardly on arm 23 to make full contact with the log 12. The inwardly moving side press roll 21 on pivot arm 23 exerts side pressure on log 12 and this action brings the log into full contact with the fixed tilted feed roll 20. As the forward end 11 of log 12 progresses and trips the second group of photocells 29 mounted on the tail end of the tilted outfeed conveyor 24, just past the cut-off saw 26, the controller will activate the encoders 81 on the vector duty electric motor 80 driving the tilted side feed rolls 20, 21, the tilted bottom feed rolls 18, 19 and activates the pivoting arm 27 on which cut-off saw 26 is mounted to index the cut-off saw in position directly behind feed roll 20. A suitable type of encoder is illustrated in U.S. Pat. No. 5,680,802. The length of the log which has passed the plane of the cut-off saw 26 is determined by the controller based on the number of encoder pulses received from the vector duty electric motor 80 and encoders 81. The tilted outfeed conveyor 24, on which log 12 advances, has a series of photocells 8 (FIG. 3, 4) mounted at predetermined intervals along the length of the conveyor. Based on the scanned information, the log 12 will be advanced along the tilted outfeed conveyor until the forward end 11 of log 12 breaks the beam of the photocell 8 which is mounted just prior to the target length. At that time the controller will begin to slow the forward progress of the log 12, and at the same time the controller utilizes the encoder pulse counts from the vector duty electric motor 80 to count the number of pulses from the time the forward end 11 of log 12 breaks the beam of the target photocell 8 to the target length of the log 12. Once the target or desired length has been reached, the rolls 18, 19, 20 and 21 are stopped automatically and the log is bucked by pivoting the cut-off saw across the log as shown in FIG. 3 and 6. With the aid of the encoder information, the log is then consecutively moved forward and stopped by the rolls 18, 19, 20 and 21 at the desired locations according to the scanner information to cut the log at the optimum lengths. The feed rolls are able in this way to move the log rapidly between successive cutting positions. The system can also be manually over-ridden by an operator and defects, which are picked up by the operator, can be manually bucked out of the logs.

The throughput speed of the sawing or bucking process is increased by sensing of the log diameters as the log is advanced through the system. The hydraulic cylinder 40 or pneumatic cylinder 340 which controls arm 23 which pivots the tilted feed roll 21 is equipped with a TEMPOSONIC™ linear positioner or pneumatic linear positioning system which senses the length of the stroke on the hydraulic cylinder or pneumatic cylinder which controls the arm 23 and thereby generates a signal indicative of the diameter of the log, which is also used for pre-positioning of the tilted feed roll 21 as the log moves forward. This information is compared to the scanning information to confirm that the log is being scanned at the proper location. The log diameter information is also used to pre-position the cut-off saw 26 as well as control the stroke of the saw when the log is bucked. For example, as the diameter of the log changes, the rest position of the cut-off saw will be moved towards or away from the log to reduce the distance the cut-off saw must swing to saw the log. The length of the stroke or swing of the cut-off saw is also determined by the measured diameter of the log so that the cut-off saw can complete its stroke and return to its start position in the minimum time, thereby maximizing throughput.

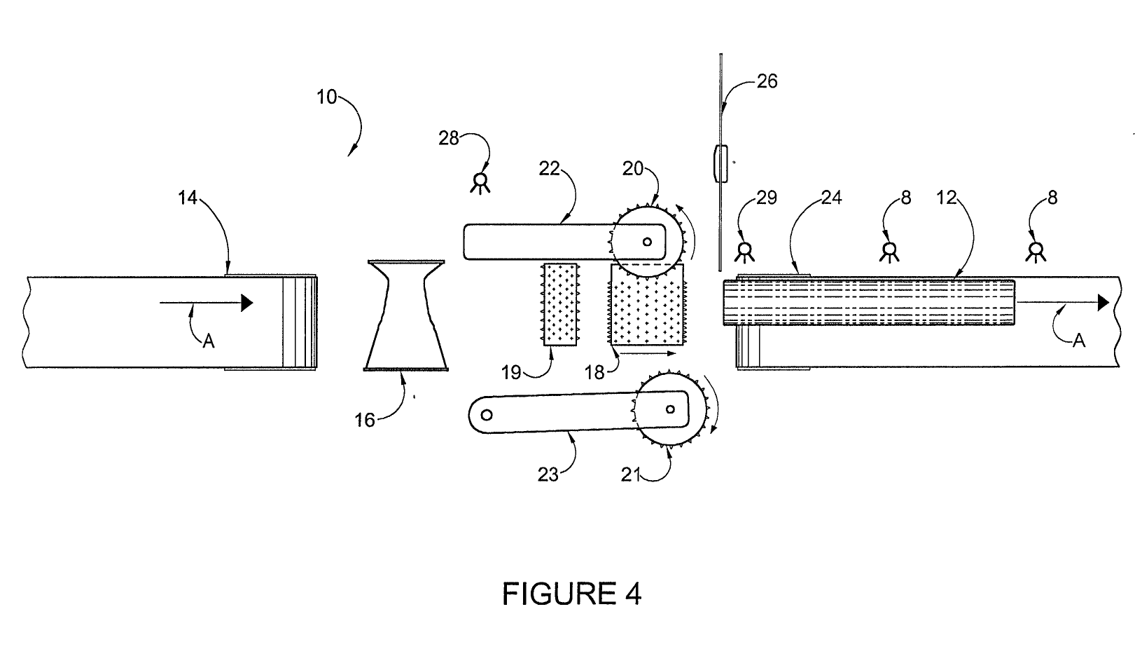

Predetermined desired lengths for the log segments to be cut from a tree-length log can be pre-programmed into the system so that as the next programmed length is approached the vector duty electric motors automatically start to slow the log down and stop at the target length. The cut-off saw is then automatically activated and cycled to cut the log. Once the first segment is bucked from the log, the feed rolls advance the log at very high speeds to the next programmed length for bucking. Meanwhile, the segment of the log which has been bucked can advance at high speed on the outfeed conveyor 24 to the next processing stage (see FIG. 4).

Since the infeed and outfeed conveyors continue to feed during the intervals when rolls 18, 19, 20, and 21 are stopped to buck the log, gaps between the logs are reduced and the throughput is increased. The higher throughput speed during sawing is also achieved through the use of the vector duty electric motors and encoders on the feed rolls. It has also been found that the infeed conveyor can be co-ordinated with the feed rolls 18, 19, 20, and 21 to stop and go in conjunction with them, and still obtain benefits in increased throughput, as the outfeed will continue to operate while the log is bucked.

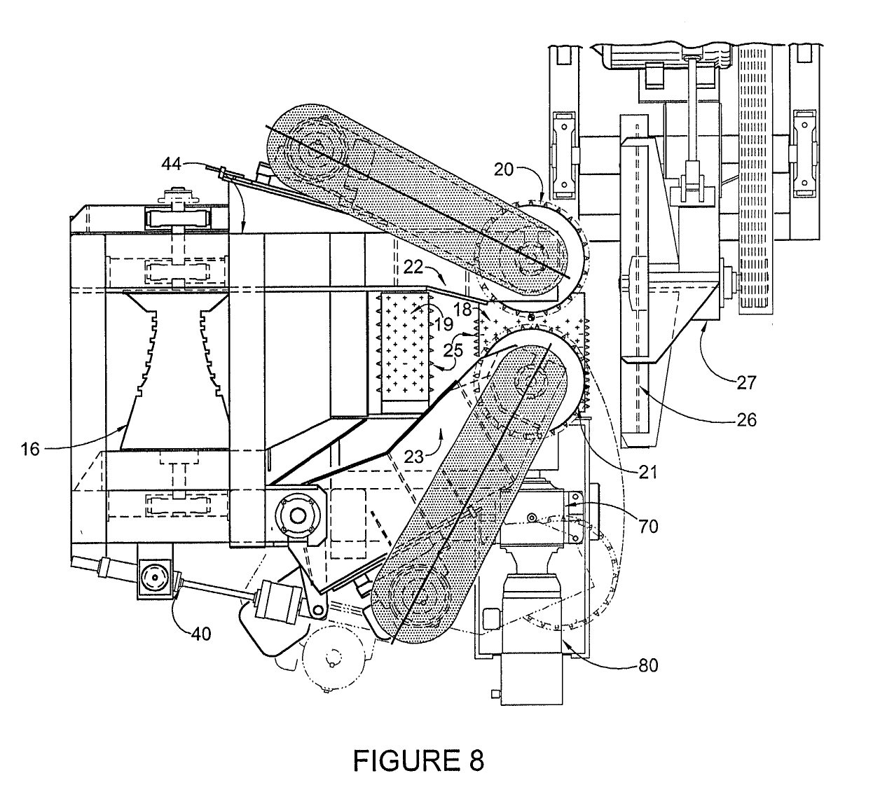

The preferred form of the invention uses tandem pneumatic/hydraulic cylinder 40 REXROTH™ MXO-PP/ME6-HH with a TEMPOSONIC II™ probe system or pneumatic cylinder 340 with pneumatic linear positioning system to move the arm 23. Since the tree-length logs coming into the feed system may be either top or butt first, the feed rolls must move with the taper of the log as it advances through the system. As the rolls move with the taper, they must still maintain constant pressure on the log, preventing the rolls from slipping and producing inaccurate log lengths. The hydraulic or pneumatic circuit is designed such that a constant pressure is maintained on the log at all times. However irregularities in the log such as knots or burls will also be encountered by the feed rolls moving at considerable speed, which will tend to cause the rolls to lose contact with the surface of the log. To reduce this effect the hydraulic cylinder 40 is provided with an associated pneumatic cylinder. The pneumatic cylinder (FIG. 7 and 8), operating at low air pressure, is mounted in tandem with the hydraulic cylinder 40 to absorb and dampen any sudden movement to maintain contact of the feed rolls on the log. Another alternative to dampen sudden movement is to provide a pneumatic cylinder 340 with pneumatic linear positioning system.

Another aspect of the control system for the vector duty electric motors is a feature to maintain accurate log positioning at high throughput speeds. As the speed of the log increases, considerable momentum or inertia is built up, so that when the system tries to stop the log at the desired position, there is a tendency for the log to overshoot. The control system for the vector duty electric motors has a built-in system for overcoming this tendency, but to ensure log length accuracy, the series of photocells 8 have been placed along the tilted outfeed conveyor 24. When the forward end 11 of log 12 passes photocell 29, the controller activates the encoder 81 on the vector duty electric motors 80, and the number of pulses required to get to the target or desired length are counted. The target or desired length is determined when the log is scanned and this information is passed off to the controller for the bucksawing apparatus 10. If, for example, the scanner information indicates that a length of twelve feet three inches (12′3″) is the desired length, then when the forward end of log 12 passes photocell 29, the number of pulses required to get to the twelve foot (12′) photocell array are counted until the photocell beam array at that position is broken by the forward end 11 of log 12, at which time the controller will ramp or slow the forward progress of the log 12. The encoder pulse counts will continue to be counted until the forward end 11 of log 12 gets to the target length of twelve feet three inches (12′3″) at which time the log will be stopped automatically and the log bucked by pivoting the cut-off saw across the log as shown in FIG. 3 and FIG. 6.

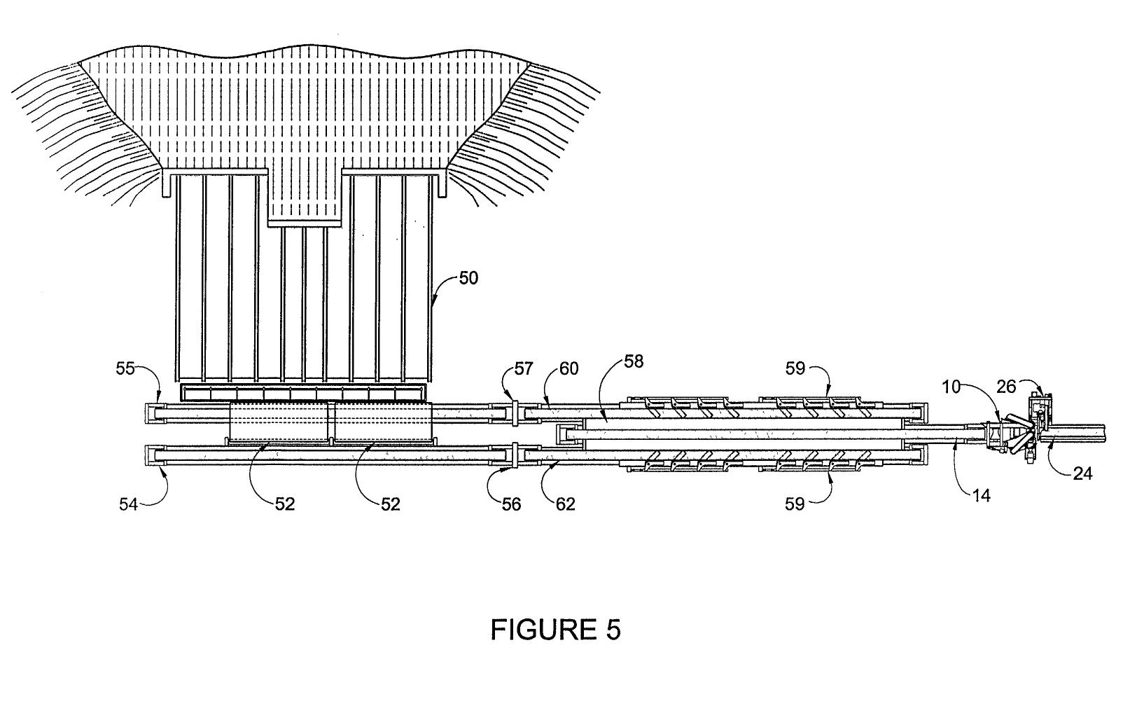

Conventional lineal scanning systems require a large area or space for the tree length log deck, infeed conveyor(s) to the scanner(s), scanner(s), and scanner outfeed conveyor prior to the conventional type of log cut-off saws. In conventional transverse log processing systems, the log is transported transversely through the system, after being singulated and scanned, through a battery of saws that can buck the log to various lengths that are determined from the log scanning data. These systems, until now, are very expensive to build and maintain as well as lacking the flexibility of a lineal bucking system. In the present invention, various lineal systems can be used to feed the logs to the bucksawing apparatus 10. For example, as illustrated in FIG. 5, logs are transported transversely on a log deck 50 to a diverter gate 52 where they are diverted onto one of two parallel conveyors 54, 55 which transport the logs longitudinally through two parallel log scanners 56, 57 and from there by parallel conveyors 60, 62 to a log indexer 58 where two log sweeps 59 alternately sweep the logs onto infeed conveyor 14 and from there to the bucksawing apparatus 10.

Alternatively, the logs coming from deck 50 can be singulated using a star feeder (not shown) to deposit logs onto an hourglass roll conveyor (not shown) that moves the log longitudinally to an adjustable end stop (bumper) (not shown) that can be set at “0” such that the leading end of the log is established on the “log line” or the bumper can be retracted 3″, 6″, 9″ or 12″ behind the “log line” depending on the amount that the operator wants to remove from the butt or leading end of the log. After the log has been ended on the hourglass roll conveyor, a lugged chain transfer deck (not shown) moves each log transversely and separately through a log scanning system, which scans each log as it moves transversely on the deck, and also through a stationary end trim saw. The logs are then fed onto the lineal infeed conveyor 14. This arrangement reduces gaps between logs as they enter the present bucksawing apparatus 10.

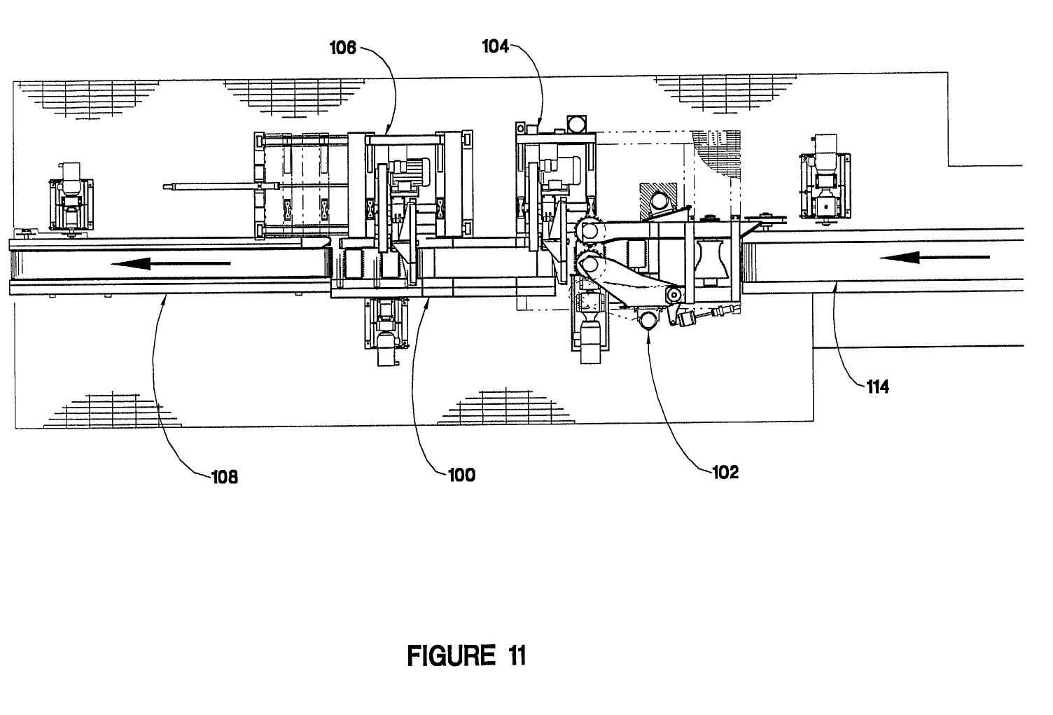

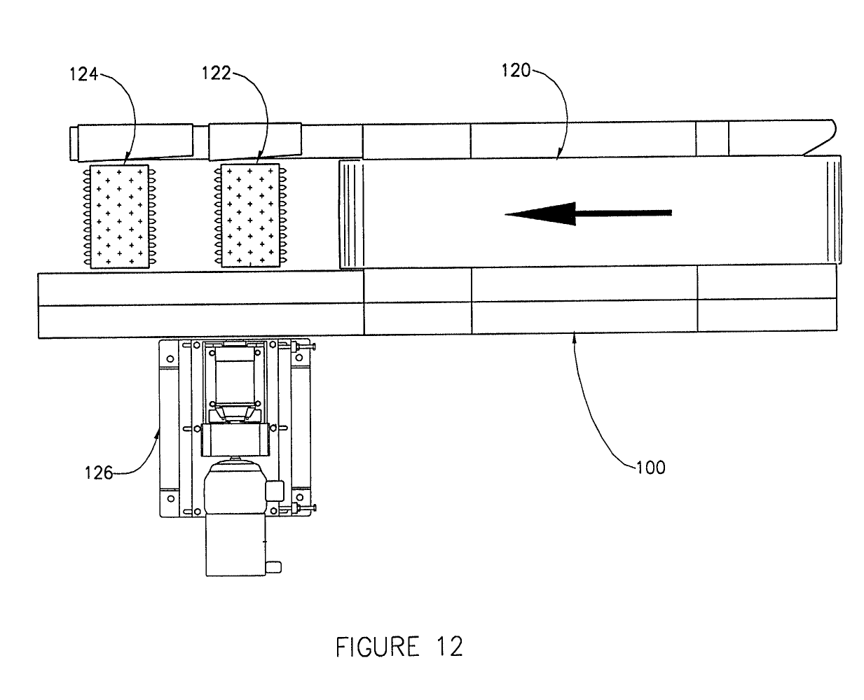

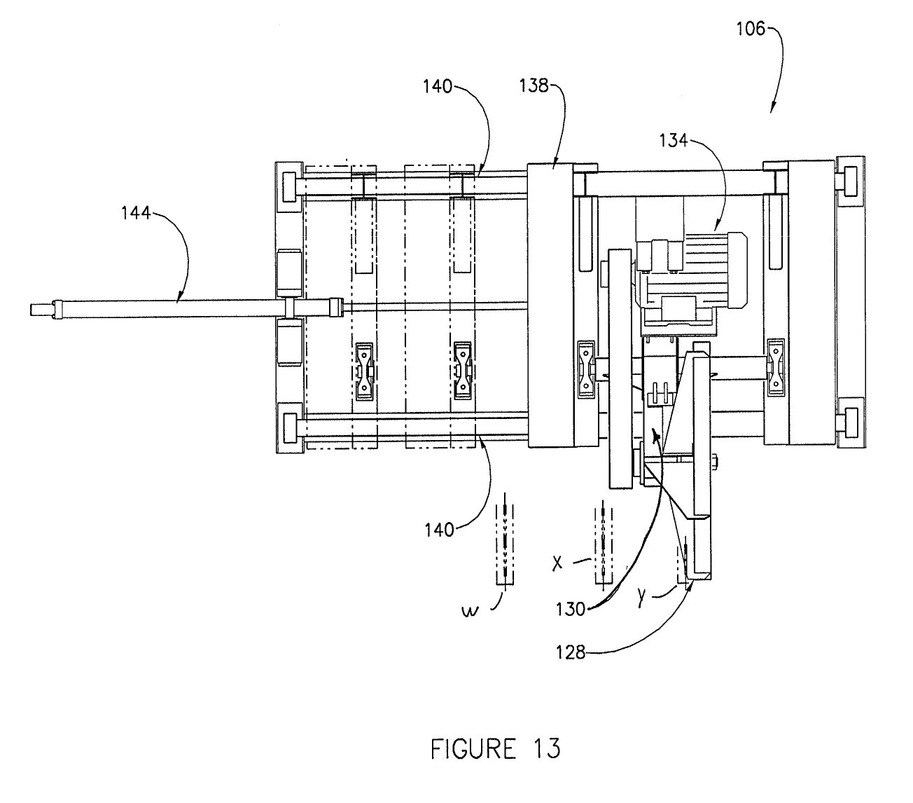

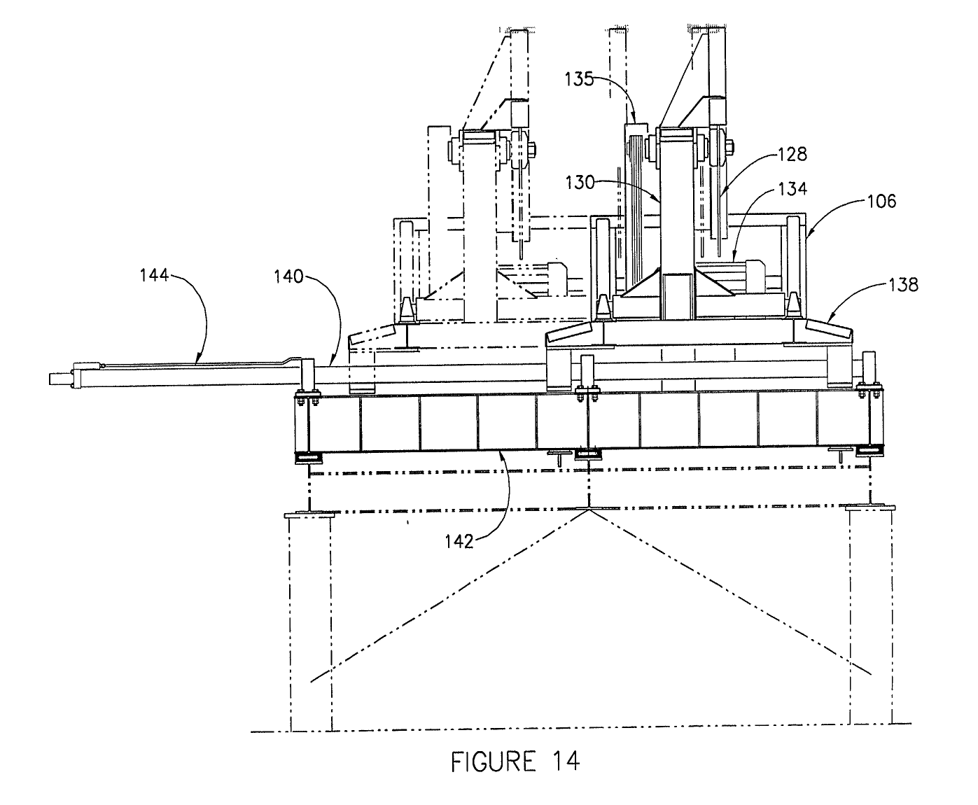

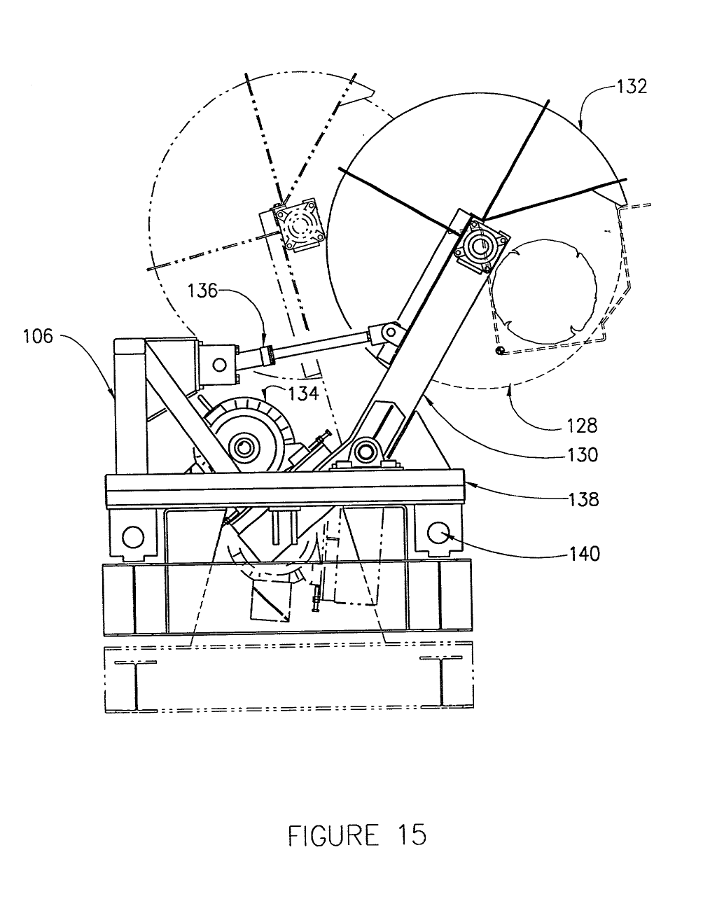

The invention may also provide dual cut-off saws to further improve throughput speed. Referring to FIG. 11, a single tilted infeed conveyor 114 feeds logs to bucksawing apparatus 102 which operates in the same manner as bucksawing apparatus 10 above. First outfeed conveyor assembly 100 extends between fixed cut-off saw 104 and multi-positional cut-off saw 106, described in further detail below. Second outfeed section 108 carries processed logs away from the bucksawing apparatus. Fixed cut-off saw 104 operates in the same manner as cut-off saw 26 above. The belt conveyor 120 (FIG. 12) of conveyor assembly 100 and feed rolls 122, 124, driven by a series of belts by drive assembly 126, positions an incoming log in front of second multi-positional cut-off saw assembly 106. As shown in FIGS. 13 through 15, the multi-positional cut-off saw is provided at 128 on a pivoting arm 130 (FIG. 15) or some other conventional means for swinging the cut-off saw 128 perpendicularly across the path of the log 12. Saw 128 has a saw guard 132, and is driven by electric motor 134 through drive belt 135. Arm 130 is pivoted by a TEMPOSONIC hydraulic cylinder 136 or by a vector duty electric motor 330, encoder 331 and reducer 332, as shown in FIG. 28. Arm 130 is mounted on a movable frame 138 which slides on parallel guiding rails 140 which are mounted to fixed frame 142, or is provided with wheels (not shown) which in turn ride on rails (not shown) to permit te saw assembly 106 to roll back and forth a distance of travel P, typically at two-foot increments. A TEMPOSONIC hydraulic cylinder 144 with a 54″ stroke hydraulic cylinder, or some other designed stroke length, for example, or a vector duty electric motor 334, encoder 335 and reducer 336 (FIG. 28) which powers the positioning of frame 138 on guiding rails 140, or with wheels (not shown), to give the saw a 54″ maximum travel, or some other designed travel length. In this way, a scanned incoming log can be positioned as desired in front of the two cut-off saws. The multi-positional saw can then be positioned either between feed roll 122 and conveyor belt 120, or between feed rolls 122, 124 or after feed roll 124 and the two cutoff saws can then be activated either simultaneously or in sequence to saw the log. This gives the controller greater flexibility to reduce the amount of movement of the log required to obtain the necessary number of saw cuts.

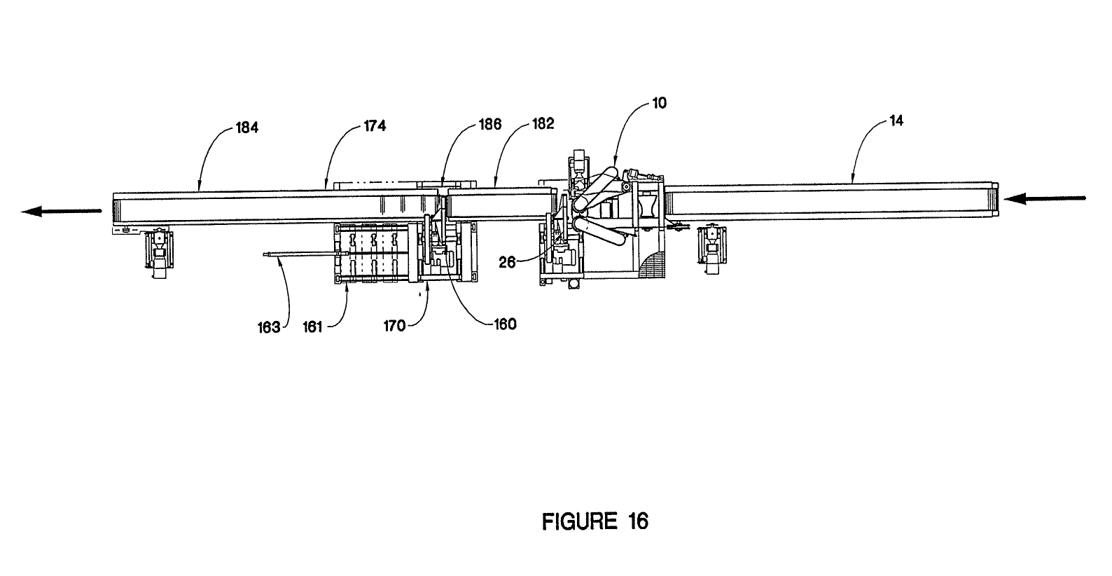

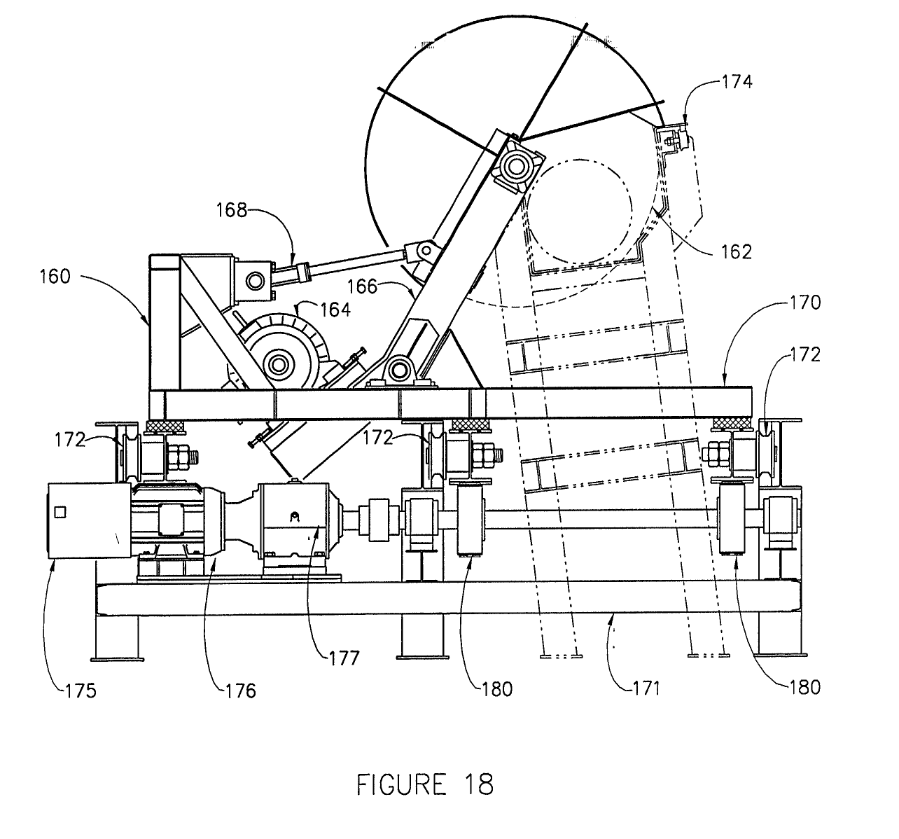

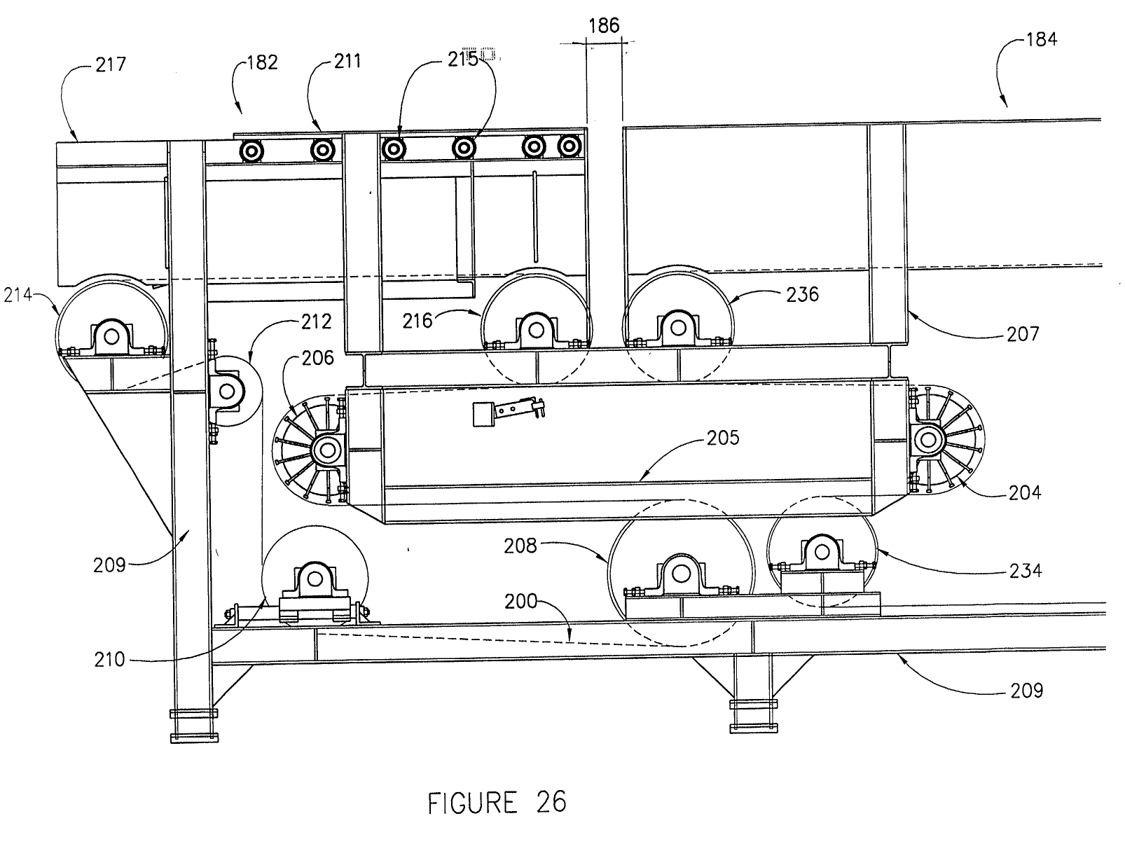

The foregoing design permits movement of the second cut-off saw to one or more positions, W, X, Y, for example at two foot intervals. A method and apparatus has also been developed to permit the second cutoff saw to be positioned at a continuum of locations within its range of travel (typically on the order of eight feet). This is accomplished by moving the conveyor belts associated with the second cut-off saw along with the cut-off saw. This embodiment is illustrated in FIGS. 16 through 26.

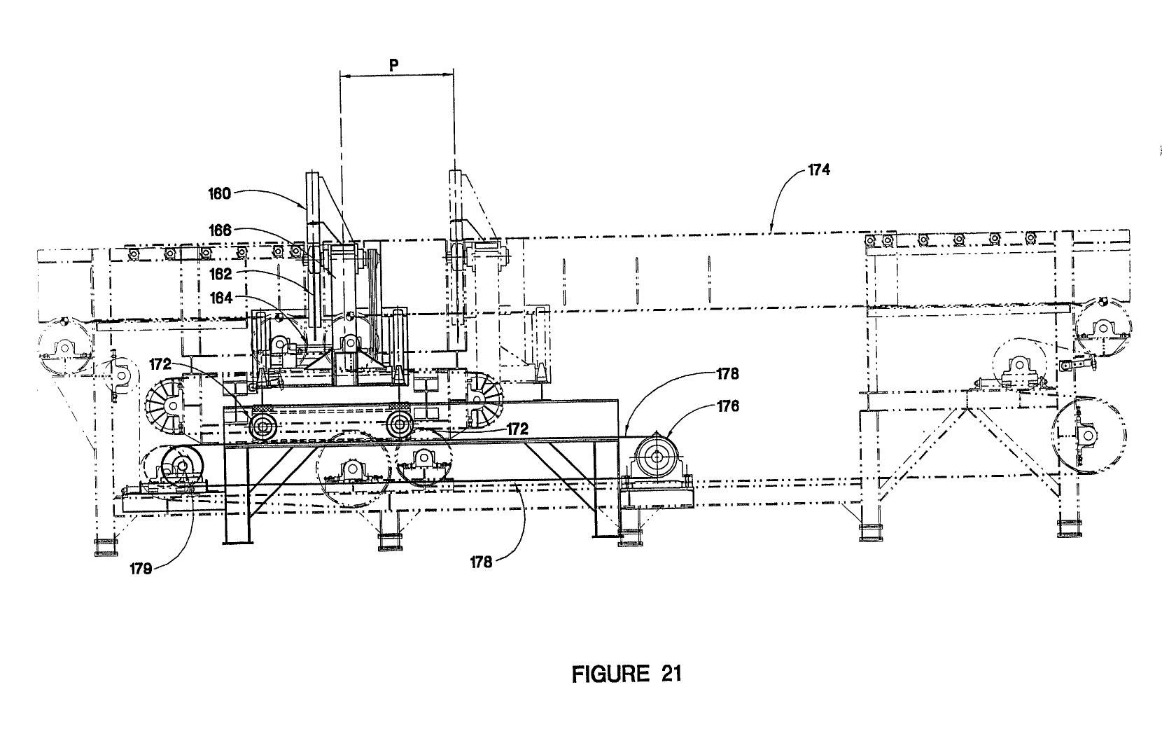

Referring to FIG. 16, tilted infeed conveyor 14 feeds logs to the bucksawing apparatus 10 as described above, having a fixed, pivoting cut-off saw 26. A second, multi-positional cut-off saw assembly 160, (see FIG. 21) as described above, comprises a circular saw 162 driven by motor 164 and pivotally mounted on arm 166 powered by hydraulic cylinder 168, or by a vector duty electric motor 330, encoder 331 and reducer 332 (FIG. 28). Saw assembly 160 is mounted on a moving frame 170 which either slides on rails 161 and is driven by a TEMPOSONIC hydraulic cylinder 163, as shown in FIG. 16 and in the embodiment shown in FIG. 13, or a vector drive electric motor 333, encoder 334 and reducer 335 (FIG. 28), or is provided with wheels 172 which in turn ride on rails or tracks 161 to permit the saw assembly 160, and attached tilted conveyor assembly 174 to roll back and forth a distance of travel P, typically at two foot increments. Tilted conveyor assembly 174, as described further below, comprises an infeed portion 182, an outfeed portion 184, and a moving gap 186 between the infeed and outfeed portions 182, 184. By having the gap move with the saw assembly 160, the second cut-of saw can be moved to any location within its range of travel to cut the log.

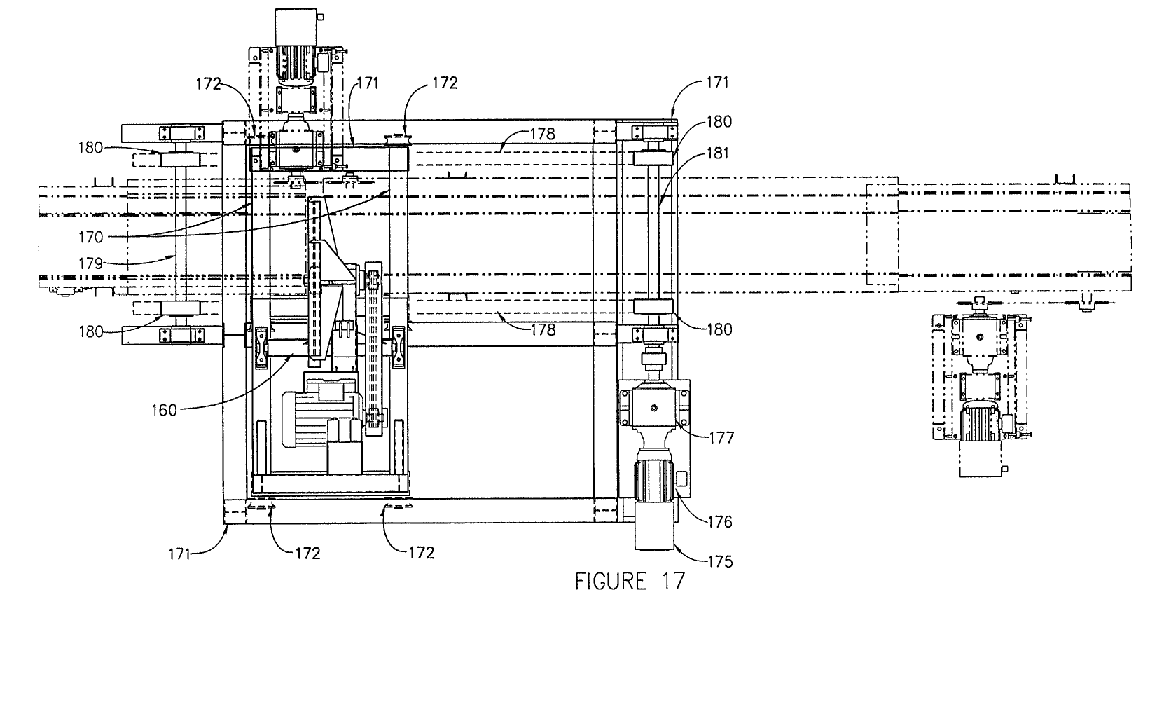

FIG. 17 illustrates the use of a vector duty electric motor 176, encoder 175 and reducer 177 to drive the frame 170 back and forth. Vector duty electric motor 176 drives two timing belts 178, connected to frame 170, through timing belt sprockets 180 on drive shaft 181 and take-up shaft 179 to move frame 170 back and forth on fixed frame 171. The use of a vector drive motor 176 and encoder 175 along with POLY CHAIN belts 178 and sprockets 180 ensures very accurate positioning of the multi-positional saw assembly 160.

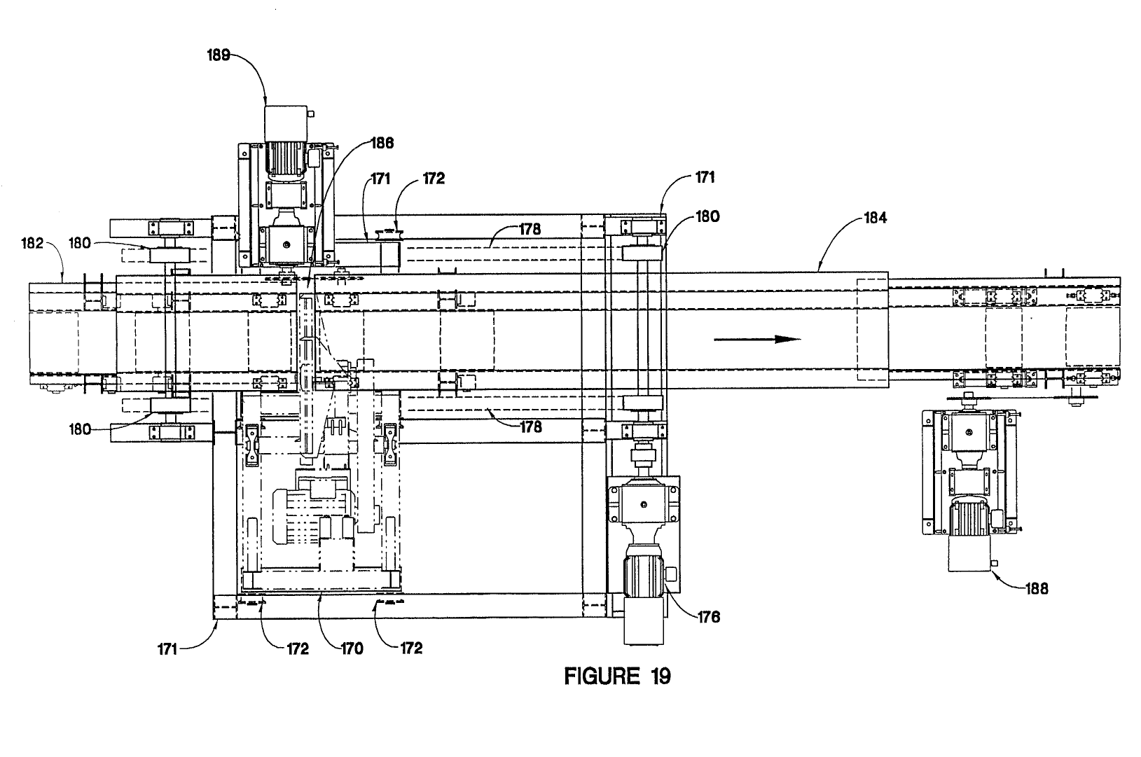

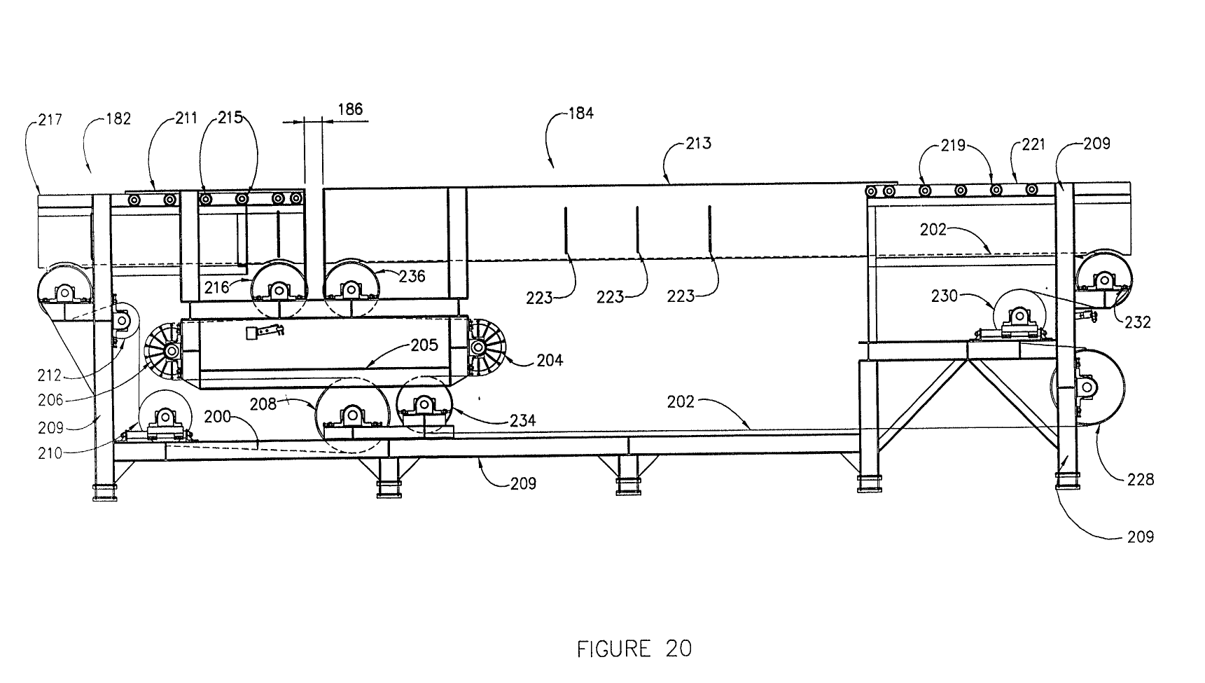

The positioning of the saw assembly 160 to the location at which it will buck a given log is predicated on the log scanning information. If, for example, a log is one hundred feet (100 feet) in length and the bucking solution from the log scanner has determined that the first two log segments are to be twenty feet (20 feet) in length, the next two segments sixteen feet (16 feet) in length and the balance being another sixteen foot (16 foot) and a twelve foot (12 foot) log. The sequence of events to achieve the desired result would be as follows. Referring to FIG. 16, the tilted conveyor 14 feeds the log to the bucksawing apparatus 10 as described above, having a fixed, pivoting cut-off saw 26. As log 12 (see FIG. 1) passes through the bucksawing apparatus the front end of log 11 breaks the beam of photo-cells 28. At this time the scanning information, bucking solution or “que” is passed to the computer central processing unit or programmable logic controller (not shown) which controls the operation of the tilted bottom rolls 18, 19, tilted fixed side roll 20, tilted side press roll 21, cut-off saw pivot arm 27, and cut-off saw 26 as well as the second, multi-positional cut-off saw 160, moving frame 170, tilted conveyor assembly 174, which comprises of an infeed portion 182 and outfeed portion 184 (see FIG. 16). Using the above log sample of a one hundred foot (100 foot) log with the first two segments to be bucked being twenty feet (20 feet). As soon as the “que” is passed the second multi-positional saw 160 will move, along with the tilted conveyor assembly 174 which comprises of the infeed portion 182, the gap 186, and outfeed portion 184, to a position twenty feet (20 feet) from the fixed cut-off saw 26. The log 12 will be advanced along the tilted outfeed conveyor 184 until the forward end of log 11 of log 12 breaks the beam of photocell 223 (see FIG. 20) which is mounted just prior to the target length. At that time the controller will begin to slow the forward progress of the log 12, and at the same time the controller utilizes the encoder pulse counts from the vector duty electric motors 80 and encoders 81 to count the number of pulses from the time the forward end 11 of log 12 breaks the beam of the target photocell 223 to the target length of the log 12. Once the target or desired length has been reached, the feed rolls 18, 19, 20, 21 and the infeed belt 200 (see FIG. 20) of infeed portion 182 of tilted conveyor assembly 174 are stopped automatically. The log is then automatically bucked by simultaneously pivoting log cut-off saws 26 and 162 across the log. Once the log has been bucked and the saws 26 and 162 are retracted the infeed portion of belt conveyor 200 will start and the multi-positional cut-off saw assembly 160 along with the tilted conveyor assembly 174 will shift to the next saw position based on the “que” or log scanning information. In this case the multi-positional saw assembly would shift to the sixteen foot (16 foot) position and the process repeated. The construction of the shifting conveyor system 174 is shown in FIGS. 19 and 20. It comprises an infeed conveyor section 182 and outfeed conveyor section 184 separated by a gap 186, which will be typically 6 inches, through which cut-off saw 162 passes. VFD drive assembly 188 drives the outfeed conveyor section 184 and VFD drive assembly 189 drives the infeed conveyor section 182. Both infeed conveyor section 182 and outfeed conveyor section 184 are secured to and move with frame 170 and wheels 172 on fixed frame 171.

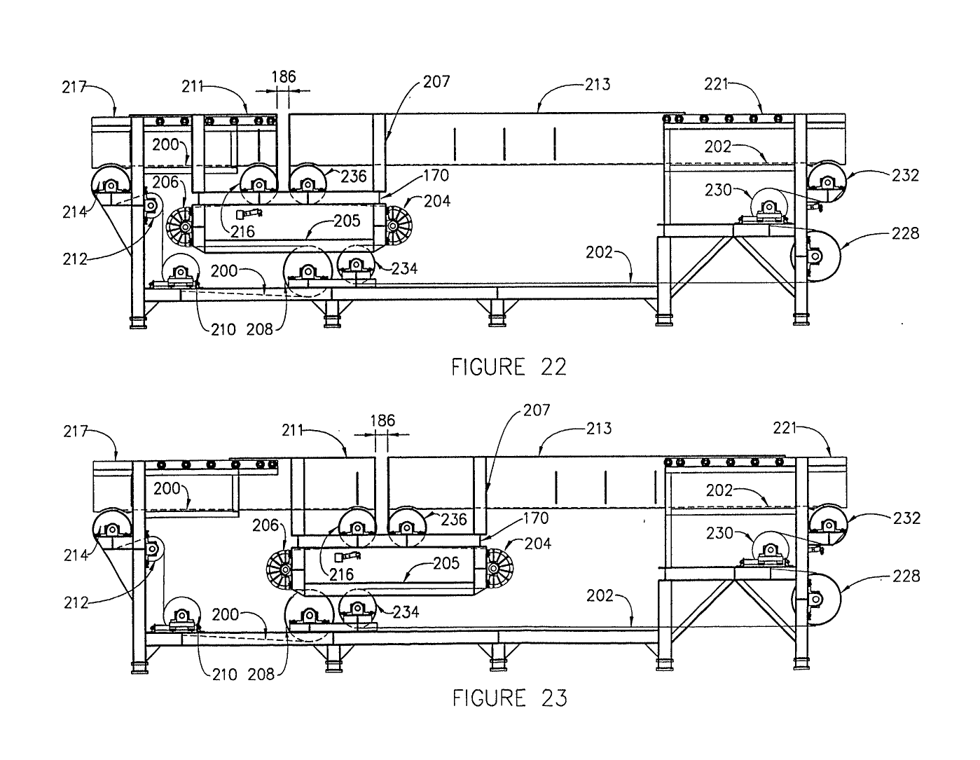

Infeed conveyor section 182 and outfeed conveyor section 184 each have separate conveyor belts 200, 202 (FIG. 20) which are each of fixed length and able to continue to move while the conveyor sections are shifting due to the provision of moving wing pulley arrangements 204, 206, 216, 236. Lagged drive pulley 208 is secured to fixed frame 209, as is take-up pulley 210 which is provided with a travel take-up frame to tighten the belt, snub pulley 212, and lagged pulley 214. Lagged drive pulley 228 is secured to fixed frame 209, as is take-up pulley 230, lagged pulley 232 and lagged pulley 234. Winged pulleys 204, 206 and pulleys 216, 236 are secured to moving frame 205 which in turn is secured to moving conveyor frame 207, consisting of infeed slide trough 211 and outfeed slide trough 213. Moving conveyor frame 207 is secured to movable frame 170 to roll on wheels 172 (FIG. 21). Infeed slide trough 211 rolls on, and is supported by wheels 215 mounted on fixed infeed trough section 217 and outfeed slide trough 213 rolls on, and is supported by wheels 219 mounted on fixed outfeed trough section 221. Infeed slide trough 211 telescopes outside fixed infeed trough section 217, whereas outfeed slide trough 213 telescopes inside fixed outfeed trough section 221, as shown in FIG. 22, 23. In FIG. 22, the gap 186 is at its maximum left-hand position. After activation of vector duty electric motor 176, the frame 170 has been moved a number of two foot increments to the right, for example 8 feet, and gap 186 has similarly moved 8 feet to the right. This is possible because the span of infeed conveyor belt 200 between pulleys 214 and 216 has been increased the same length as the amount of decrease in the span between pulleys 206 and 208, and similarly the span of the outfeed conveyor belt 202 between pulleys 232 and 236 has been decreased the same length as the amount of increase in the span between pulleys 204 and 234.

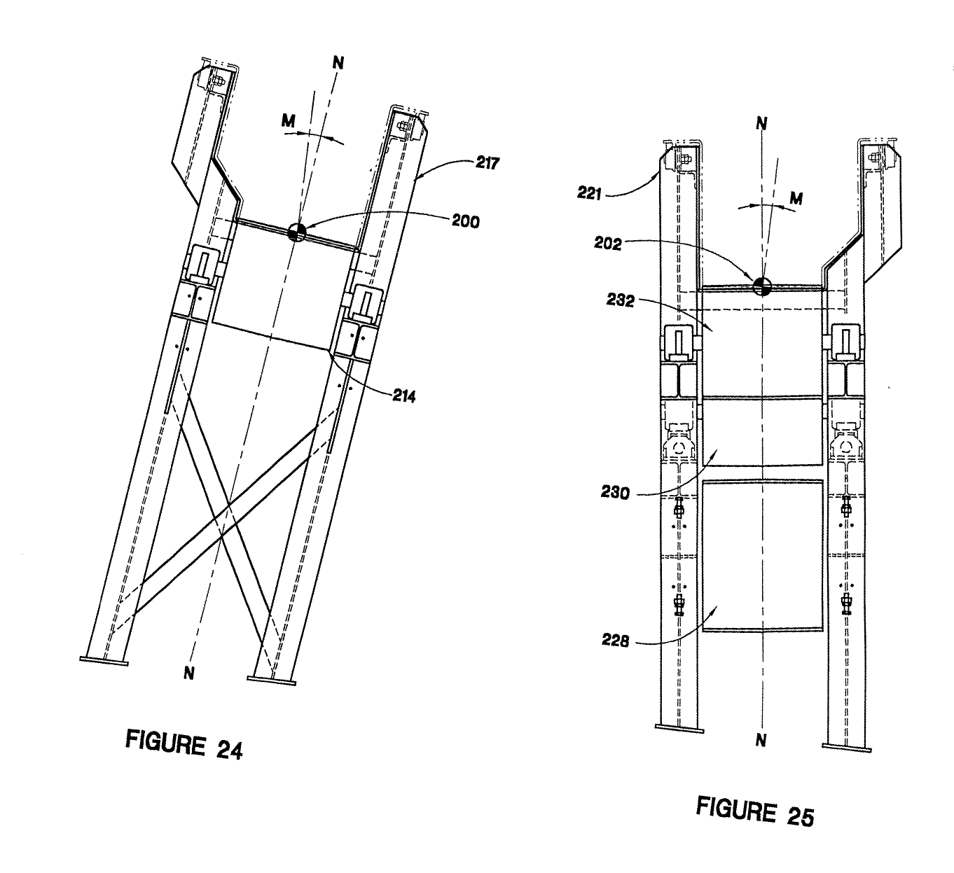

Conveyor troughs 211, 213, 217, 221 are constructed of steel plate having a steel plate surface on which conveyor belts 200, 202 slide. Slider or friction back belts are used to reduce friction. As shown in FIGS. 24, 25, belts 200, 202 run at a tilted angle N to the vertical M which is preferably about 7 degrees. Photocell arrays 8 are provided at regular increments on the outfeed conveyor, so a series of slots 223 (FIG. 20) are provided in the outfeed sliding trough 213 to align with the photocell arrays at each incremental location. The computer, central processing unit or programmable logic controller (not shown) which controls the operation of the bucksawing apparatus can be set to have the second cut-off saw spaced at any desired incremental distances from the first cut-off saw 26, so that the logs could be cut in 8, 10 and 12 foot lengths, or metric lengths, or custom lengths.

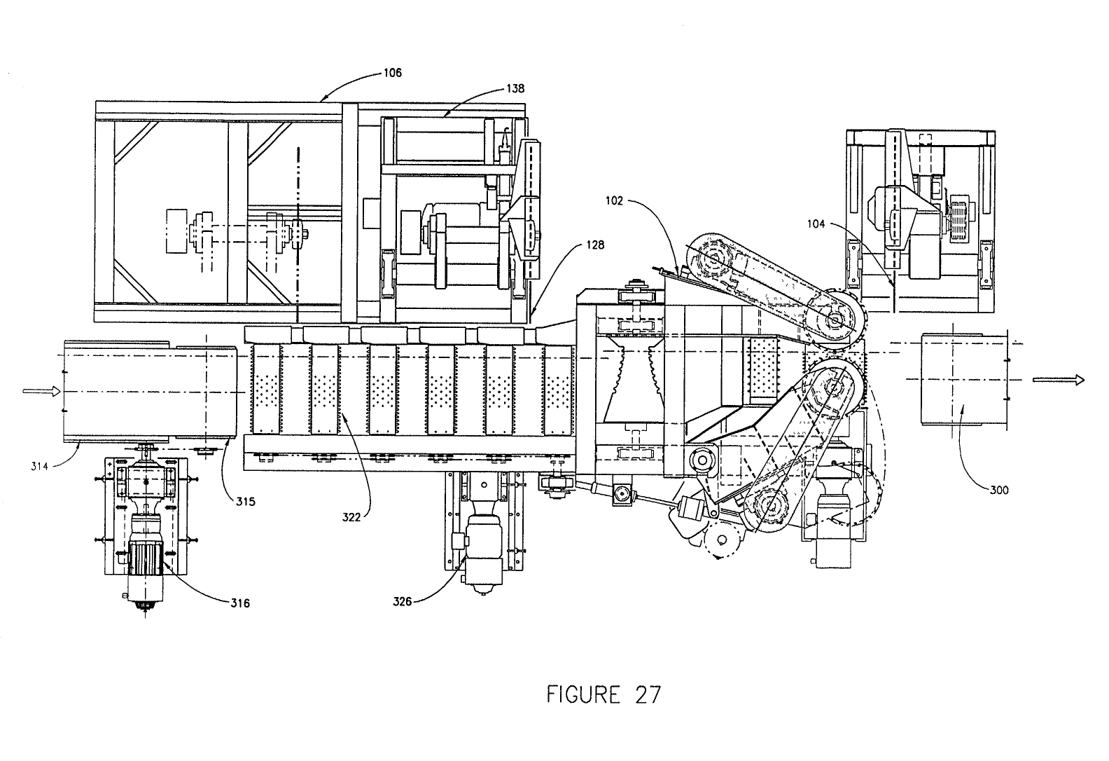

FIG. 27 illustrates a further embodiment of the invention in which one of the dual cut-off saws 106 is positioned on the infeed conveyor to -further improve throughput as well as enhancing the gaps between bucked log segments. Single infeed conveyor assembly 314 feeds logs to bucksawing apparatus 102, which operates in the same manner as bucksawing apparatus 10 above. The first outfeed conveyor assembly 300 carries processed log segments away from the fixed cutoff saw 104. Fixed cut-off saw 104 operates in the same manner as cut-off saw 26 above. The conveyor belt 315 of conveyor assembly 314 is driven by a variable frequency drive and infeed rollcase 322 which is driven by belts or chains using a vector drive assembly 326, and positions an incoming log in front of the multi-positional cut-off saw assembly 106. As in the embodiment described in FIGS. 13 through 15, the multi-positional cut-off saw is provided at 128 on a pivoting arm 130, or some other conventional means for swinging the cut-off saw 128 perpendicularly across the path of the log 12. The multi-positional saw can then be positioned between the infeed rolls of rollcase 322, or between infeed rollcase 322 and the conveyor belt 315, and the two cut-off saws can then be activated either simultaneously or in sequence to saw the log. This again gives the controller greater flexibility to reduce the required amount of movement of the log 12 to obtain the necessary number of saw cuts. Again this design permits the movement of the multi-positional cut-off saw to one or more positions, for example as shown in phantom outline in FIG. 27.

FIG. 28 illustrates a further embodiment of the invention in which the first multi-positional cut-off saw 106 is positioned on the infeed rollcase 322 and the second multi-positional cut-off saw 306 is positioned after the bucking saw apparatus 102 to further improve throughput speeds, provide automatic log gapping, and buck undefined, odd, or non-standard log lengths. A single tilted infeed conveyor assembly 314 feeds logs to bucksawing apparatus 102, which operates in the same manner as bucksawing apparatus 10 above. The first outfeed conveyor 300 carries bucked segments (logs) away from the second multi-positional cut-off saw 306. The second multi-positional cut-off saw 306 operates in the same manner as the first multi-positional cut-off saw 106 in FIGS. 11 through 15 above. The conveyor belt 315 of conveyor assembly 314 is driven by a variable frequency drive and infeed rollcase 322 is driven by a series of belts or chains by a vector duty drive assembly 326, and positions an incoming log in front of the multi-positional cut-off saw assemblies 106 and 306. As in the embodiment described in FIGS. 13 through 15, the multi-positional cut-off saw is provided at 128 on a pivoting arm 130, or some other conventional means for swinging the cut-off saw 128 perpendicularly across the path of the log 12. The first multi-positional cut-off saw 106 can then be positioned between the rolls of infeed rollcase 322, or between the infeed rollcase 322 and the conveyor belt 315. The second multi-positional cut-off saw 306 can then be positioned to various positions through a range of up to 2 feet. Once the two cut-of saws are in their designated positions based on the “que” or log bucking solution that has been determined by the log scanner, the two log cut-off saws can then be activated either simultaneously or in sequence to saw the log to undefined, odd or non-standard lengths. This again gives the controller greater flexibility to reduce the required amount of movement of the log 12 to obtain the necessary number of saw cuts. Again this design permits the movement of the first and second cut-off saw 128 to move to various positions, as shown in phantom outline in FIG. 28, thereby giving the system the capability of producing infinitely many or odd lengths.

The positioning of the saw assemblies 160 and 306 to the location at which it will buck a given log is predicated on the log scanning data or information. If, for example, a log is sixty feet (60 feet) in length and the bucking solution from the log scanner has determined that the first two log segments are to be fifteen feet, three inches (15′-3″) and thirteen feet, nine inches (13″-9″) respectively, in length and the next segment sixteen feet, three inches (16′-3″) and the remainder fourteen feet, nine inches (14′-9″), the sequence of events would be as follows. Referring to FIG. 28, the tilted infeed conveyor 314 feeds the log onto the infeed rollcase 322 which in turn advances the log to the bucksawing apparatus 102, having a multi-positional pivoting cut-of saw 306. As the log 12 passes through the bucksawing apparatus 102, the front end of the log 11 breaks the beam of photocells 28. At this time, the scanning information, bucking solution or “que” is passed to the computer central processing unit or programmable logic controller (not shown) which controls the operation of the tilted bottom rolls 18, 19, tilted fixed side roll 20, tilted side press roll 21, cut-off saw pivot arm 27, and multi-positional cut-off saws 106 and 306, moving frames 138 respectively. As soon as the “que” is passed, the first multi-positional cut-off saw 106 will move to a position along the infeed rollcase 322 such that the cut-off saw blade 128 or 26 (see FIG. 3) will always be positioned between the rolls on the infeed rollcase 322, or between the rollcase 322 and the infeed belt conveyor 315. The second multi-positional cut-off saw 306 will move, based on the “que” that has been passed, to a position 15′-3″ from the first multi-positional cut-off saw 106. The log 12 will advance along the tilted outfeed conveyor 300 or 24 (see FIG. 3) until the forward end 11 of the log 12 breaks the beam of photocell 8 (see FIG. 3) which is mounted along the sides of the outfeed conveyor 300 or 24. At that time the controller will begin to slow the forward progress of the log 12, and at the same time the controller will utilize the encoder pulse counts from the vector duty electric motors 80 and encoders 81 to count the number of pulses from the time the forward end 11 of log 12 breaks the beam of the target photocell 8 to the length of the log 12, which in this case is 15′-3″. Once the target or desired length has been reached, the feedrolls 18, 19, 20 and 21 and the tilted conveyor assembly of infeed rollcase 322 are stopped automatically. The log is then automatically bucked by simultaneously pivoting log cut-off saws 128 of multi-positional cut-off saw assemblies 106 and 306 across the log. Once the log has been bucked, both cut-off saws 128 are retracted and the first log segment, which is in this case 15′-3″, will automatically move down the belt conveyor 300, and the bucksawing apparatus 102 will advance the next bucked log segment, which in this case is 13′-9″, out and onto belt conveyor 300. The portion of log 12 remaining on the infeed rollcase 322 will be advanced into the bucksawing apparatus 102 and the log 12 will be advanced to the next target length. Both multi-positional cut-off saws 306 and 106 will move to the next cutting position so that when log 12 has reached the next target or desired length based on the “que”, the multi-positional cut-off saw will be ready to automatically buck the log, which in this case will be 16′-3″.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of sawing a log into segments of predetermined lengths comprising utilizing dual multi-positional cut-off saws in a bucksawing station with one multi-positional cut-off saw being positioned on an infeed conveyor.

2. A method of sawing a first log of a plurality of logs into segments of predetermined lengths comprising
a) feeding said plurality of logs end to end in a direction parallel to the axis of said logs on a first input log-feeding means;
b) transferring said first log from said first log-feeding means onto a second log-feeding means aligned collinearly with said first log-feeding means;
c) successively positioning said first log on said second log-feeding means in a direction parallel to the axis of said first log at said predetermined lengths for sawing;
d) sawing said first log at each of said pre-determined lengths to form said segments utilizing first and second movable saws positioned upstream and downstream from said second log-feeding means respectively; and
e) moving each said segment after being sawn onto a third output log-feeding means and then away from said second log-feeding means, while continuing to feed subsequent logs in said plurality of logs on said first log-feeding means to said second log-feeding means.

3. The method of claim 1 wherein said first input log-feeding means is tilted to a degree sufficient to roll said log to one side of said log-feeding means.

4. The method of claim 1 wherein said third output log-feeding means is tilted to a degree sufficient to roll said log to one side of said log-feeding means.

5. The method of claim 1 wherein said step of sawing said first log at each of said pre-determined lengths to form said segments is carried out by dual saws pivotable across the line of travel of said first log.

6. The method of claim 5 wherein said dual saws are movable along the axis of motion of said log.

7. The method of claim 5 wherein said second saw movable across the line of travel of said first log located downstream of said first saw and movable along the axis of motion of said log further comprises conveyor means having an infeed portion and an outfeed portion separated by a gap movable in association with said second saw.

8. The method of claim 4 wherein said degree of tilting is approximately 7 degrees.

9. Apparatus for sawing a log into segments of a predetermined length comprising:
a) a first log-feeding means for feeding a log in an end-wise line of travel;
b) a second horizontally oriented log-feeding means adapted to receive said log from said first log-feeding means;
c) first and second, vertically oriented log-feeding means, said first tilted, vertically oriented log-feeding means mounted for pivotal movement from a first non-log-engaging position to a second log-engaging position;
d) power means for pivoting said first, vertically oriented log-feeding means from said first non-log-engaging position to said second log-engaging position and back to said first non-log-engaging position;
e) dual multi-positional cut-off saws located upstream and downstream respectively of said second horizontally oriented log-feeding means, said dual saws being movable across the line of travel of said log on said second horizontally oriented log-feeding means;
f) means for measuring the distance traveled by said log while on said second tilted, horizontally oriented log-feeding means and communicating said measurement to a control means;
g) power means for moving said saw in response to a control signal;
h) a third horizontally oriented log-feeding means adapted to receive said log from said second tilted horizontally oriented log-feeding means and lying in a horizontal plane slightly below the horizontal plane of said second tilted horizontally oriented log-feeding means; and
i) control means for receiving said measurement signal and communicating control signals to said power means for moving said saw and controlling said first and second tilted vertically oriented log-feeding means;
wherein said first and second vertically oriented log-feeding means are adapted to advance and stop said log in response to said control signal; and wherein said means for measuring the distance traveled by said log measures the advance of the log while on said second horizontal log-feeding means and communicates said measurement to said control means; said first and second vertically oriented log-feeding means stop the log at the desired length; said saw cuts the log to produce a forward log segment; and said forward log segment is advanced onto said third horizontally oriented log-feeding means.

10. The apparatus of claim 9 wherein said first, second and third horizontally oriented log-feeding means and said first and second vertically oriented log-feeding means are tilted to a degree sufficient to roll said log to one side of said log-feeding means.

11. The apparatus of claim 10 wherein said first, second and third horizontally oriented log-feeding means are tilted approximately 7 degrees from the horizontal and said first and second vertically oriented log-feeding means are tilted approximately 7 degrees from the vertical.

12. The apparatus of claim 9 wherein said multi-positionable saws are movable along the axis of motion of said log.

13. The apparatus of claim 9 wherein said means for measuring the distance travelled by said log while on said second horizontally oriented log-feeding means comprise hydraulic motors for driving said first and second vertically oriented log-feeding means, having sensors for measuring the number of rotations of said motors.

14. The apparatus of claim 9 wherein said means for measuring the distance travelled by said log while on said second horizontally oriented log-feeding means comprises first sensing means for sensing the approach of said log to said first and second vertically oriented log-feeding means and causing said power means to pivoting said first log-feeding means into said log-engaging position, means for measuring the distance traveled by said log while engaged by said first and second vertically oriented log-feeding means, and second sensing means for sensing when the front end of said log reaches a position after said first and second vertically oriented log-feeding means.

15. The apparatus of claim 9 further comprising means for scanning said log prior to said log being received on said second horizontal log feeding means.

16. The apparatus of claim 9 wherein said second horizontally oriented log-feeding means comprises a powered hourglass roll and a tilted horizontally oriented bottom feed roll.

17. The apparatus of claim 9 wherein said first and second vertically oriented log-feeding means comprise vertical feed rolls pivotally mounted on the ends of arms, said first vertically oriented log-feeding means being pivoted by said power means.

18. The apparatus of claim 9 further comprising sensing means associated with said power means for pivoting said first vertically oriented log-feeding means for generating a signal indicative of the diameter of the log and communicating said signal to said control means.
